(19) United States
(12) Patent Application Publication
(10) Pub. No.: US 2014/0299721 A1
(43) Pub. Date: Oct. 9, 2014

(54) Hose Clamp Brace

(71) Applicant: Tomasz Habrzyk, Fillmore, CA (US)

(72) Inventor: Tomasz Habrzyk, Fillmore, CA (US)

(21) Appl. No.: 14/231,377

(22) Filed: Mar. 31, 2014

Related U.S. Application Data
(60) Provisional application No. 61/809,233, filed on Apr. 5, 2013.

(51) Int. Cl. F16L 33/03

(52) U.S. Cl. CPC F16L 33/03
USPC 248/73

(57) ABSTRACT

A hose clamp brace providing additional structure to two sections of tubing that are joined by a section of hose. Typical hose and hose clamps are used, and the hose clamp brace comprises a tubing clamp attached to each section of tubing, and a connecting element coupled to the tubing clamps. The connecting element may couple to the tubing clamps with fastening elements. This assembly provides additional integrity for the hose connection, and resists connection failure better than the hose and clamps alone. The fastening elements may be on the tubing clamp or the connecting element.

### CROSS-REFERENCE TO RELATED APPLICATION

This patent application claims the benefit of U.S. Provisional Patent Application Ser. No. 61/809,233, entitled “Hose Clamp Brace,” filed Apr. 5, 2013, which application is incorporated in its entirety here by this reference.

### TECHNICAL FIELD

This invention relates to hose clamps and efforts to strengthen the connection between the hose and the tubing.

### BACKGROUND

A hose clamp is used for fastening a typically bare hose to tubing. Common automotive applications of a hose-tubing connection utilizing a hose clamp may include making fluid flow into a brake, an air conditioning system, a power steering apparatus, an engine intake (including supercharged and turbocharged applications), or an engine compartment. Common industrial applications of such combination are for the flow of fluid in other industrial Places. The purpose of the hose clamp is to prevent the hose from being separated from the Tubing.

A hose clamp typically comprises a single band that wraps around the end of the hose that is covering a tube. When the clamp is tightened, the hose is held in place by the friction between the hose and the tube. Although some clamps include compensation means so as to prevent the clamp from losing its fixing force, other clamps do not. In addition, in certain high pressure applications the hose clamp cannot create sufficient friction to prevent the hose from slipping off the tubing. In certain applications where two sections of tubing are connected with a short piece of hose held in place with two hose clamps, high pressure may overcome the friction created by the hose clamp, and blow apart the connection.

What is needed is a hose clamp that has an independent means for maintaining the connection between the hose and the tubing.

### SUMMARY

The present invention is directed to a hose clamp brace to maintain a connection between two sections of tubing connected by a hose with conventional clamps. The hose clamp brace is used where two adjacent sections of tubing are connected by a hose with conventional clamps. The hose clamp brace comprises two tubing clamps, one of which is removably attached to the first section of tubing adjacent to the hose, and the other is removably attached to a second section of tubing adjacent to the hose. A fastening element is coupled with each tubing clamp, and a connecting element is coupled with each of the fastening elements. In some applications, it may be desirable to have at least two fastening elements on each clamp, with a corresponding connecting element for each fastening element.

The hose clamp brace holds the two sections of tubing in place, independent of the hose connection. This improves the physical connection of the hose, as it relieves the strain on the hose to keep the two tubing sections from coming apart, allowing the hose to simply hold the pressure. The hose clamp brace mostly relies on the friction between the tubing clamp and the tubing, which is usually higher than the friction between the hose and the tubing. In addition, the tubing clamp is attached to the tubing, which unlike the hose, has less of a tendency to deform, degrade, or change shape over time or with temperature or pressure.

Hose clamps can loosen over time simply due to the deformation of the hose. If the hose is the only connection between the tubing, the connection can blow apart as the hose slips off the tubing. With the hose clamp brace, even if the hose clamp loosens, the hose will stay in place and the connection will not blow apart, even if the hose may leak slightly.

In many applications, hose clamps are used in conjunction with a single barb or flange on the tubing, to assist the hose clamp to retain the hose on the tubing. On thin-wall tubing, the barb may be formed by a tubing end former that deforms the entire tube diameter. In some applications, it may be desirable to use completely smooth tubing, without barbs or flanges formed in the tubing interior that would disrupt the linear flow of the fluid. In such applications, it is more difficult to retain a hose with a simple hose clamp. Using a hose clamp brace would improve the ability to retain the hose on the tubing, since the tubing is held in place by the hose clamp brace and the hose merely has to hold the pressure.

### BRIEF DESCRIPTION OF DRAWINGS

FIG. 1 shows a perspective view of the prior art with two sections of tubing connected by a section of hose that is held in place by hose clamps.

FIG. 2 shows a partially exploded perspective view of an embodiment of the present invention being used in conjunction with the prior art.

FIG. 3 shows an assembled perspective view of an embodiment of the present invention being used in conjunction with the prior art.

FIG. 4 shows an assembled perspective view of an embodiment of the present invention being used in conjunction with the prior art, showing the adjustability of the invention to accommodate varying lengths of hose.

FIG. 5 shows a perspective view of another embodiment of the present invention.

FIG. 6 shows an assembled perspective view of another embodiment of the present invention being used in conjunction with the prior art.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

In high pressure applications, including but not limited to supercharged or turbocharged engine systems, typical hose clamps may provide insufficient mechanical force to keep the hose connected with the tubing. Limitations in such mechanical force may include the coefficient of friction between the hose and the tubing, the amount of deformation in the hose, both initially and over time, and the maximum clamping force that can be placed on the tubing.

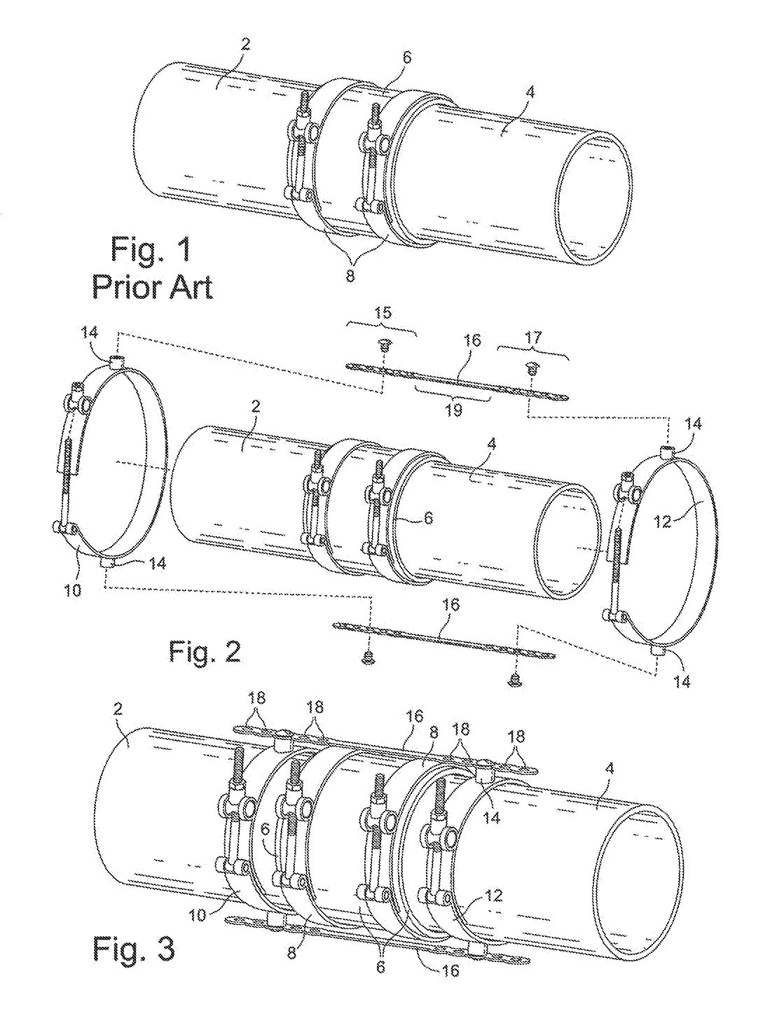

In applications where two sections of tubing 2, 4 are connected with a short section of hose 6, it is possible to increase the strength of the hose connection while simultaneously relieving some of the tension on the hose 6, by adding a brace to either side of the hose 6. FIG. 1 depicts the prior art, with a first section of tubing 2 and a second section of tubing 4, connected by a hose 6 with a hose clamp 8 on either side of the connection. This connection relies on the mechanical connection between the hose 6, the hose clamp 8 and the tubing 2, 4. FIG. 2 shows the elements of the hose clamp brace, including the tubing clamps 10, 12, fastening elements 14, and connecting elements 16. FIG. 3 shows the prior art in conjunction with an embodiment of the hose clamp brace. The hose clamp brace may comprise two tubing clamps 10, 12, a first tubing clamp 10 removably attached to the first section of tubing 2, and a second tubing clamp 12 removably attached to a second section of tubing 4. Preferably, the first section of tubing 2 is coupled to the hose at one end of the hose 6, and the second section of tubing 4 is coupled to the opposite and of the hose 6. The first tubing clamp 10 is attached to the first section of tubing 2 adjacent to but beyond the hose 6. Similarly, the second tubing clamp 12 is attached to the second section of tubing 4 adjacent to but beyond the hose 6. In other words, in the preferred embodiment, the tubing clamps 10, 12 are coupled to the section of tubing 2, 4 and not the hose 6.

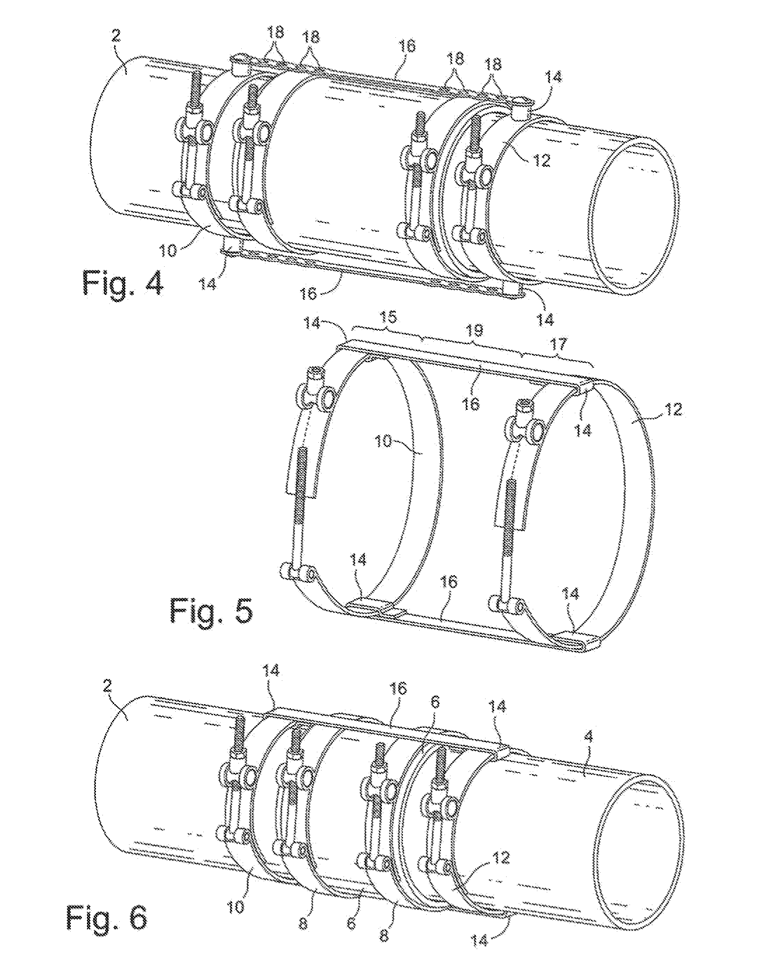

The tubing clamps 10, 12 may comprise a standard hose clamp, or may be specially designed for the application. As such, in the preferred embodiment, the tubing clamps 10, 12 are cylindrical bodies configured to wrap around the sections of tubing 2, 4. The tubing clamps 10, 12 can be wrapped around the hose 6 if desired. A screw tightening mechanism is shown in FIGS. 2-6 for the tubing clamps 10, 12 but any suitable tightening mechanism could be used. In some embodiments, coupled with each of the tubing clamps 10, 12 is a fastening element 14, which may comprise a post with internal or external threads. The fastening element 14 may be permanently or removably attached to the tubing clamp 10, 12, by adhesives, welding, or other suitable attachment methods. Preferably, such attachment methods would leave the interior of the tubing clamp 10, 11 with a smooth profile, avoiding any protrusions that might create pressure points on the tubing 2, 4. In some applications, the tubing 2, 4 may be strong enough to withstand such pressure points, or creating indentations in the tubing may not be detrimental to the function of the tubing, and in such cases, the tubing clamp 10, 12 may have protrusions on its interior surface.

Each fastening element 14 is then coupled with a connecting element 16, so that the two fastening elements 14 and their respective tubing clamps 10, 12 are mechanically connected. In the embodiment shown in FIGS. 2-4, the connecting element 16 is a strip, made of metal, plastic, webbing, carbon fiber, or other suitable material that is strong enough to hold the two sections of tubing 2, 4 together under working pressure. The connecting element 16 may have a first end 15, a second end 17 opposite the first end 15, and a middle section 19 therebetween, wherein the first tubing clamp 10 is coupled to the first end 15 of the connecting element 16, and the second tubing clamp 12 is coupled to the second end 17. In one embodiment, the connecting element 16 may be constructed of a metal strip with a plurality of holes 18 used to adjust the length of the connecting element 16 by using various holes 18 to attach the metal strip to the fastening element 14. Preferably, the plurality of holes 18 are located at the first and second ends 15, 17, or can be located throughout the length of the strip. The connecting element 16 may be secured to the fastening element 14 by a screw or a nut, or other suitable attachment structures. As shown in FIGS. 2-4, a hose clamp brace may have two connecting elements 16, with corresponding fastening elements 14. In other embodiments, more or fewer connecting elements and fastening elements may be used. When two or more connecting elements 16 with corresponding fastening elements 14 are used, the connecting elements 16 may be evenly spaced apart around the tubing clamps 10, 12. For example, when two fastening elements 16 are used, they may be positioned diametrically opposed to each other as shown in FIGS. 2-6.

When the entire connection is assembled, the hose clamp brace provides a much more robust connection between the first and second sections of tubing 2, 4 than the hose 6 and hose clamps 8 alone. The tubing clamps 10, 12 provide a more secure mechanical connection because the clamp is tightened directly to the tubing 2, 4, without an intervening layer of deformable hose 6. This provides a connection that it less likely to slip than a hose clamp 8. In addition, because the hose clamp brace is taking the strain of the pressure that is trying to force the two sections of tubing apart at the hose connection, the hose itself is relieved of that mechanical tension, improving the hose's connection and longevity. Although most applications for the hose clamp brace will involve the tubing under pressure, the hose clamp brace could be adapted for a vacuum as well, with the connecting elements 16 holding the tubing 2, 4 apart.

One advantage of using the tubing clamps 10, 12 of the present invention is the ability to adjust the hose clamp brace to fit any connection,. In an alternative embodiment, however, the tubing clamps 10, 12 may be omitted and fastening elements (the post style) may be fixed directly onto the tubing 2, 4. This would require lining up the fastening elements on the tubing 2, 4 to connect them with a connecting element 16. In another embodiment, a single tubing clamp 12 may be used. In such an embodiment, the first section of tubing 2 would have the fastening element (the post style) fixed directly on the tubing 2, and a tubing clamp 12 with a fastening element 14 would be placed on the second section of tubing 4, with sufficient adjustability to allow easy connection for various sized assemblies. The fastening element 14 on the first section of tubing 2 would be connected to the fastening element 14 on the tubing clamp 12 by the connecting element 16.

In the embodiment shown in FIGS. 2-4, the connecting element 16 is equipped with a plurality of holes 18 along its length. These holes can be used to make large changes in length of the hose clamp brace, to allow a single size of brace to accommodate a wide variety of assemblies with varying lengths of hose.

An alternative embodiment of the hose clamp brace is shown in FIGS. 5-6. This embodiment may employ a connecting element 16 that is integral with the fastening element 14. In this embodiment, the connecting element 16 and the two fastening elements 14 may be formed from a metal strip, which loops under or over the tubing clamp (i.e. wraps around a portion of the tubing clamp), and may be welded, glued, or otherwise fastened to the metal strip so that the loop contains a portion of the tubing clamp. In this manner, the connecting element 16 is coupled with the tubing clamps 10, 12. Although this embodiment does not have the same length-wise adjustability of the embodiment that uses the connecting element with a plurality of holes (FIGS. 2-4), this embodiment (FIGS. 5-6) provides a simpler and less costly manufacturing method. The fastening element 14 in this embodiment may comprise a metal strap that is flush with the strap of the tubing clamp 10, 12 as shown in FIG. 5, which may cause the fastening element 14 to be slightly deformed as it traverses the hose 6 and hose clamps 8 of the assembly. Alternatively, a spacer (not shown) may be employed between the exterior of the tubing clamp 10, 12 and the fastening element 14, which would raise the connecting element 16 to clear the hose 6 and hose clamps 8.

The fastening element 14 for the embodiment shown in FIGS. 5 and 6 may be formed from common bar stock with a rectangular profile having opposing first and second ends and opposing side edges adjacent to the first and second ends. Such a profile may create pressure points on the tubing 10, 12 at the edges of the fastening element 14, which may be desirable in some embodiments. Alternatively, bar stock with a tapered profile may be used for the fastening element 14 and/or the connecting element 16, to reduce the angle of contact on the tubing 10, 12. In other words, the side edges may be tapered so as to create a smoother transition from the side edge to the tubing 10, 12. In yet another embodiment, an adapter (not shown) may be used either under or adjacent to the sides of the bar stock to reduce or eliminate any sharp angles on the 10, 12. In such an embodiment, the side edges of the adapter may be tapered.

In some embodiments, the connecting element 16 may be coupled to the first and second tubing clamps 10, 12 in an adjustable manner. For example, the connecting element 16 may be located at multiple positions along the perimeter of the tubing clamps 10, 12. In the embodiment shown in FIGS. 2-4, this can be accomplished by creating a plurality of posts intermittently spaced apart about the perimeter of the tubing clamps 10, 12. This also allows multiple connecting elements to be attached to the tubing clamps 10, 12 for added strength.

For the embodiment shown in FIGS. 5-6 the adjustability can be accomplished by coupling the connecting element 16 in a slidable manner so that the position of the connecting mechanism 16 may be adjustable along the perimeter of the tubing clamps 10, 12.

In use, a hose and tubing can be connected by providing a hose 6 having a first end and a second end opposite the first end, coupling a first section of tubing 2 with the first end of the hose 6, coupling a second section of tubing 4 with the second end of the hose 6, clamping the first section of tubing 2 with a first tubing clamp 10 adjacent to the first end of the hose 6, and clamping the second section of tubing 4 with a second tubing clamp 12 adjacent to the second end of the hose 6. The first tubing clamp 10 and the second tubing clamp 12 may already be fastened together by a connecting element 16. In some embodiments, the first tubing clamp 10 and the second tubing clamp 12 are fastened together by attaching the connecting element 16 to the first and second tubing clamps via fastening elements 14. In embodiments in which the fastening elements 14 protrude radially away from their respective tubing clamp 10, 12, the user may adjust the distance between the tubing clamps 10, 12. In some embodiments, multiple connecting elements 16 may be used to fasten the tubing clamps 10, 12 together. In some embodiments, the fastening elements 14 may wrap around a portion of their respective tubing clamp 10, 12.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

### INDUSTRIAL APPLICABILITY

This invention may be industrially applied to the development, manufacture, and use of pressurized hose connections between sections of tubing.

What is claimed is:

1. A hose clamp brace that provides a strengthened connection between two sections of tubing, the hose clamp brace comprising:
a. a first tubing clamp having a first cylindrical body coupled with a first section of Tubing;
b. a second tubing clamp having a second cylindrical body coupled with a second section of tubing; and
c. a connecting element attachable to the first tubing clamp and the second tubing clamp via fastening elements to fix a distance between the first tubing clamp and the second tubing clamp, wherein the connecting element is a flat strip comprising a first end, a second end opposite the first end, and a middle section therebetween.

2. The hose clamp brace of claim 1, wherein the first and second tubing clamps each comprises a plurality of fastening elements evenly spaced apart and around the first and second cylindrical bodies.

3. The hose clamp brace of claim 1, wherein the fastening elements are posts protruding radially away from their respective tubing clamps, and the connecting element comprises a plurality of holes at the first end and the second end, wherein the connecting element is attachable to the posts through a first hole at the first end, and a second hole at the second end.

4. The hose clamp brace of claim 1, wherein a first fastening element is at the first end of the connecting element and configured to wrap around a portion of the first tubing clamp, and wherein a second fastening element is at the second end of the connecting element and configured to wrap around a portion of the second tubing clamp.

5. The hose clamp brace of claim 4, wherein the first and second fastening elements are slidably coupled to their respective tubing clamp.

6. A hose clamp brace that provides a strengthened connection between two sections of tubing, the hose clamp brace comprising:
a. a first tubing clamp coupled with a first section of tubing;
b. a second tubing clamp coupled with a second section of tubing; and
c. a connecting element attachable to the first tubing clamp and the second tubing clamp via fastening elements to fix a distance between the first tubing clamp and the second tubing clamp.

7. The hose clamp brace of claim 6, wherein the connecting element is a flat strip comprising a first end, a second end opposite the first end, and a middle sections therebetween, wherein the first tubing clamp is coupled to the first end of the connecting element, and the second tubing clamp is coupled the second end.

8. The hose clamp brace of claim 7, further comprising a plurality of connecting elements spaced apart around the first and second tubing clamps.

9. The hose clamp brace of claim 7, wherein the fastening elements are posts protruding radially away from the their respective tubing clamps, and the connecting element comprises a plurality of holes at the first end and the second end, wherein the connecting element is attached to the posts through a first hole at the first end, and a second hole at the second end.

10. The hose clamp brace of claim 7, wherein the distance is adjustable.

11. The hose clamp brace of claim 7, wherein a first fastening element is at the first end and configured to wrap around a portion of the first tubing clamp, and wherein a second fastening element is at the second end and configured to wrap around a portion of the second tubing clamp.

12. The hose clamp brace of claim 11, wherein the first and second fastening elements are slidably coupled to their respective tubing clamp.

13. A method of connecting hoses and tubing, comprising:
a. providing a hose having a first end and a second end opposite the first end;
b. coupling a first section of tubing with the first end of the hose;
c. coupling a second section of tubing with the second end of the hose;
d. clamping the first section of tubing with a first tubing clamp adjacent to the first end of the hose; and
e. clamping the second section of tubing with a second tubing clamp adjacent to the second end of the hose, wherein the first tubing clamp and the second tubing clamp are fastened together by a connecting element.

14. The method of claim 13, wherein the first tubing clamp and the second tubing clamp are fastened together by attaching the connecting element to the first and second tubing clamps via fastening elements.

15. The method of claim 14, wherein the fastening elements protrude radially away from their respective tubing clamp.

16. The method of claim 14, wherein the fastening elements wrap around a portion of their respective tubing clamp.
